(19) United States
(12) Patent Application Publication
(10) Pub. No.: US 2008/0237928 A1
(43) Pub. Date: Oct. 2, 2008

(54) CASTING DEVICE, SOLUTION CASTING APPARATUS, AND SOLUTION CASTING METHOD

(75) Inventors: Kimito Washiya, Kanagawa (JP); Tomoaki Nagahara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,642

(22) Filed: Mar. 28, 2008

(30) Foreign Application Priority Data
Mar. 28, 2007 (JP) 2007-084429

(51) Int. Cl. B29C 39/22; B29C 55/02

(52) U.S. Cl. 264/291; 425/470

(57) ABSTRACT

A casting dope is cast onto a casting belt to form a casting film, and then the casting film is peeled as a wet film from the casting belt. The wet film is guided through a transfer area toward a tenter drying device. In the tenter drying device, a tenter performs sequentially the drying, the stretching and the relaxation of the wet film during transporting the wet film. On the wet film, a bowing phenomena occurs by the relaxation to generate a first disorientation of an optical axis, and therefore the orientation of slow axed becomes not uniform. The stretching provide a second disorientation of the optical axis so as to cancel the first disorientation. Thus in the obtained film, the nonuniformity of the orientation of the slow axes is reduced.

### BACKGROUND OF THE INVENTION

1. Field of the Invention

The present invention relates to a casting device for discharging a viscoelastic fluid, a solution casting apparatus, and a solution casting method, and especially, a casting device for discharging a dope which contains a polymer as a raw material of a film, and a solution casting apparatus for and a solution casting method of producing a film from the dope.

2. Description Related to the Prior Art

A polymer film (hereinafter, film) is variously used as an optical functional film, since it being excellent in the excellent transparency and flexibility, and further since the film thickness can be decreased. Among the polymer film, there is a cellulose acylate film formed from cellulose acylate, and especially, a cellulose triacetate (hereinafter TAC) is used among the cellulose acylate, so as to form a TAC film. The TAC film is used as a film base of a film material, such as a photosensitive material, since having strength and inflammability. Note that, among the TAC, the averaged acetylation degree is preferably in the range of 57.5% to 62.5%. Further, the TAC film is excellent in optical isotropy, and therefore used as a protective film for a polarizing filter, an optical compensation film (for example, a wide view film and the like) in a liquid crystal display whose market becomes larger in recent years.

As a method of producing the film, there are a melt extrusion method and a solution casting method. In the melt extrusion method, the polymer is heated and molten, and then the molten polymer is extruded from an extruder to form the film. The melt extrusion method has merits in the high productivity and the low cost for furnishing the equipments. However, in the melt extrusion method, it is difficult to control the film thickness finely, and since stripes (named die line) is formed on the film, the produced film hardly has a high quality adequate to the optical film. Otherwise, in the solution casting method, a polymer is dissolved to a solvent, and thus a dope as a polymer solution is prepared. Then the dope is cast from a casting die onto a support so as to form a casting film. When the casting film has a self-supporting property, the casting film is peeled as a wet film from the support. Thereafter, in a tenter dryer, while both side edge portions of the wet film is clipped, The wet film is stretched and a relaxation thereof is made. At the same time, the wet film is dried. After the drying is made enough, the wet film is wound up as the film. In the solution casting method, the produced film is more excellent in the optical isotropy and the thickness uniformity than, and contains less foreign material than in the melt extrusion method. Therefore, the solution casting method is well known as a preferable method of producing the film, especially the optical film.

In the solution casting method, there are a stretching process and a relaxation process. In the stretching process, the wet film is stretched in a predetermined direction, and in the relaxation process, the stress relaxation is made so as to reduce a residual stress which has generated in the wet film in the stretching process. The stretching process and the relaxation process are performed, and therefore the smoothness of the produced film, the value of the retardation, and the direction of the slow axis are adjusted. Thus the optical properties are made higher. If it is designated to use a tenter and the like in the stretching process and in the relaxation process, a bowing phenomena occurs on the film. The bowing phenomena is known to cause the disorder of the slow axes in the widthwise direction of the wet film. In recent years, it is required moreover to increase the qualities, such as the contrast ratio and the brightness of the liquid crystal display. Therefore, it is required for the optical film to increase the quality, such as the reduce of the disorder of the slow axes, and therefore the improvement of a production method of the optical film. Especially, in the protective film for the polarizing filter, a very low in-plane retardation in the range of 0 nm to 5 nm is requested in order to prevent the ovalization of the linear deflection. Therefore, in the production of the film for the optical use by the solution casting method, it is the most important to make the direction and the like of the slow axis uniform in the film.

There are following methods of preventing the generation of the bowing phenomena in the solution casting method; (1) making the temperature of the side edge portions of the film higher than the middle portion; and (2) making the content of the remaining solvent in the side edge portions of the film higher than the middle portion. Further, as described in Japanese Patent Laid-Open Publication No. 2002-296422, there is the method of preventing the bowing phenomena as (3) providing a plurality of zones of different temperatures.

Further, Japanese Patent Laid-Open Publication No. 2004-314529 discloses a method of making the slow axis uniform. In the description thereof, both side edge portions of the film is held in an area of the tenter device, and the fluctuation of the content of the remaining solvent in the wet film is at most 25% in the area.

However, the bowing phenomena occurs not only by stretching the wet film with an tension in a widthwise direction, but also by transporting of the film in the tenter device and making the relaxation for releasing the tension force in the widthwise direction of the wet film. The above publications No. 2002-296444 and 2004-314529 don't include the consideration of the bowing phenomena causes by the transport and the relaxation after the stretch. Further, in the publication No. 2002-29644, it is necessary in the relaxation and the stretch to control the distributions of the content of the remaining solvent and the temperature in the widthwise direction of the wet film to a predetermined range. In this case, the control is complicating in the relaxation and the stretch, and therefore the time and the cost for the production becomes enormously long and high, which does not adequate for the mass production.

### SUMMARY OF THE INVENTION

An object of the present invention is to provide a solution casting method and a solution casting apparatus, in which the generation of the bowing phenomena is reduced at a low cost and easily, without using any special equipment.

In order to achieve the object and the other object, in the solution casting method of the present invention, a dope containing a polymer and a solvent is cast onto a support so as to form a casting film, a self supporting property is provided for the casting film, and after the casting film is peeled as a wet film from the support, a non-stretch-drying of drying the wet film with non-stretching the wet film in a widthwise direction of the wet film is performed. The wet film is dried with stretching the wet film in the widthwise direction before the non-stretch drying step, so as to cancel a first disorientation of optical axis that occurs by a bowing phenomena in the non-stretch-drying step, and the stretching is performed so as to provide the wet film with a second disorientation of optical axis for cancelling the first disorientation.

Preferably, while the stretching of the wet film is performed, the wet film as a higher temperature than a glass transition temperature Tg of the polymer, a content of a remaining solvent in the wet film is in the range of 5 wt. % to 10 wt. %, and a stretch magnitude of the stretching is at least 101% and less than 120%.

Preferably a temperature of the wet film is in the range of 20° C. to 200° C. in the non-stretch-drying step, and an extending of the wet film in the lengthwise direction is performed.

Preferably, a pre-drying of the wet film is performed before the stretch drying, an at least one of first, second third conditions is satisfied in the stretch-drying or the pre-drying: the first condition is that the temperature of the wet film is in the rage of 60° C. to 80° C. when the content of the remaining solvent in the range of 30 wt. % to 60 wt. %, the second condition is that the temperature of the wet film is in the range of 95° C. to 110° C. when the content of the remaining solvent in the range of 8 wt. % to 30 wt. %, and the third condition is that the temperature of the wet film is in the range of 100° C. to 120° C. when the content of the remaining solvent is in the range of 5 wt. % to 8 wt. %.

Preferably, the polymer is cellulose acylate.

A solution casting apparatus of the present invention includes a moving support, a casting die for casting onto the support a dope containing a polymer and a solvent, so as to form a casting film, a peeling member for peeling a casting film as a wet film from the support, and a non-stretch-drying section for drying the wet film with non-stretching in a widthwise direction. The solution casting apparatus further includes a stretch-drying section for drying the wet film with stretching in a widthwise direction. So as to cancel a first disorientation of optical axis that occurs by a bowing phenomena in the non-stretch drying section. The stretch-drying section is disposed in an upstream side from the non-stretch drying section. The stretching is performed so as to provide a second disorientation of optical axis for cancelling the first disorientation of optical axis.

Preferably, the solution casting apparatus further contains a temperature controller for controlling a temperature of the wet film in accordance with a content of remaining solvent of the wet film, and a magnitude controlling device for controlling a stretch magnitude of the stretching of the wet film in the widthwise direction.

Particularly preferably, the wet film in the stretch-drying section has a higher temperature than a glass transition temperature Tg of the polymer, and a content of a remaining solvent in the range of 5 wt. % to 10 wt. %, and a stretch magnitude of the stretching is at least 101% and less than 120% when the second disorientation is provided for the wet film.

Preferably, while the drying is performed by the non-stretching drying section, the content of the remaining solvent in the wet film is at most 5 wt. % and a temperature of the wet film is in the range of 20° C. to 200° C.

Preferably, a solution casting apparatus further includes a pre-drying device for performing a pre-drying of the wet film, the pre-drying device is disposed in an upstream side from the stretch-drying section, and at least one of first, second, third conditions is satisfied in the stretch-drying or in the pre-drying: the first condition is that the temperature of the wet film is in the rage of 60° C. to 80° C. when the content of the remaining solvent in the range of 30 wt. % to 60 wt. %, the second condition is that the temperature of the wet film is in the range of 95° C. to 110° C. when the content of the remaining solvent in the range of 8 wt. % to 30 wt. %, and the third condition is that the temperature of the wet film is in the range of 100° C. to 120° C. when the content of the remaining solvent is in the range of 5 wt. % to 8 wt. %.

According to the solution casting method of the present invention, the second disorientation of optical axis is provided with the wet film in the stretch drying step, so as to cancel the first disorientation of optical axis which has occurred by the bowing phenomena occurring in the in the non-stretch-drying step, and therefore the nonuniformity of the slow axis and the surface defect of the film are reduced while the retardation value is controlled in a predetermined range. Thus the film excellent in the optical property and the surface uniformity is produced with easiness and low cost. The film obtained by the present invention can be used adequately for an optical film in the liquid crystal display device. Further, in order to provide the second disorientation, the tenter device already know can be used, and therefore the nonuniformity of the slow axis in the film can be reduced without using the specific device.

According to the solution casting apparatus of the present invention, the stretch-drying section provide the second disorientation of optical axis for cancelling the first disorientation of optical axis which has occurred by the bowing phenomena occurring in the in the non-stretching-drying section. Therefore the nonuniformity of the slow axis and the surface defect of the film are reduced while the retardation value is controlled in a predetermined range. Thus the film excellent in the optical property and the surface uniformity is produced with easiness and low cost.

Therefore the present invention is adequate for the mass production.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is a flow chart of a film production process according to the present invention;

FIG. 2 is a schematic diagram of a film production line according to the present invention; and

FIG. 3 is a sectional view of a first embodiment of a tenter drying chamber in the film production line.

### PREFERRED EMBODIMENTS OF THE INVENTION

In followings, the preferred embodiments will be explained in detail. However, the present invention is not restricted in the description.

[Raw Materials]

As polymer of this embodiment, the already known polymer to be used for the film production may be used. For example, cellulose acylate is preferable, and triacetyl cellulose (TAC) is especially preferable. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability. Note that the dope contains a polymer and a solvent for dissolving the polymer. Further, if necessary, an additive is added to the dope.

The cellulose as the raw material of the cellulose acylate may be obtained from one of the pulp and the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure.

Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

[Dope Production Method]

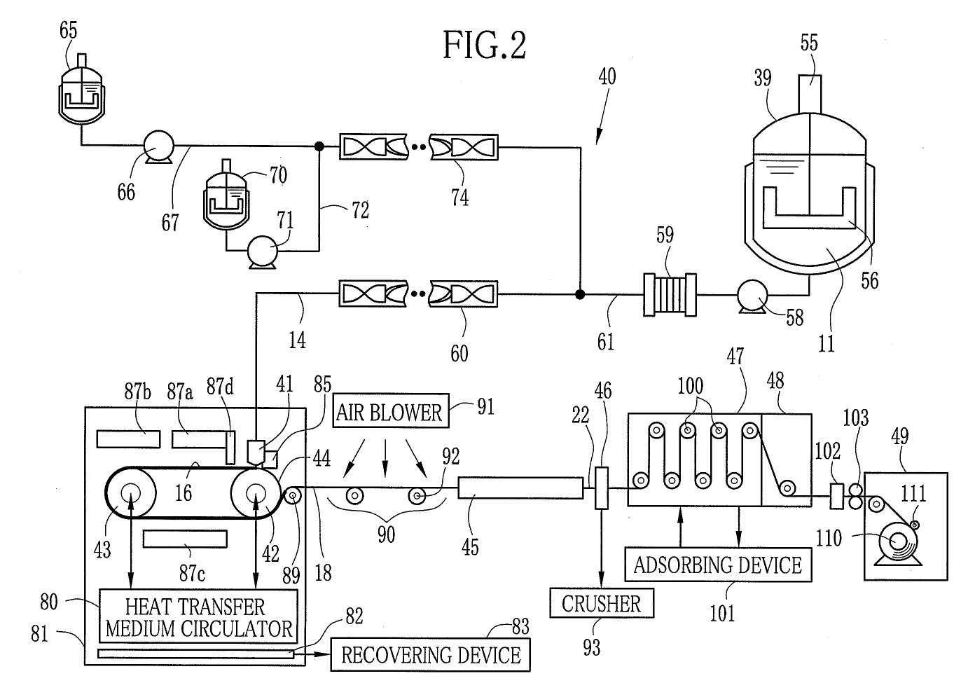

The dope is prepared from the raw materials. In the dope production line, there is a solvent tank for storing a solvent, a mixing tank for mixing a TAC and the solvent, a hopper for supplying the TAC to the mixing tank, and an additive tank for storing an additive. Further, there is a heating device for heating a swelling liquid which is obtained by mixing the TAC and the solvent as described later in detail, a temperature controller for controlling the temperature of the dope which is obtained from the swelling liquid, and a filtration device. Furthermore, there are a recovering device for recovering the solvent vapor and a refining device for refining the recovered solvent. The dope production line is connected through a stock tank 39 (see, FIG. 2) to a film production line 40.

The solvent is sent to the mixing tank by opening a bulb. Then a necessary amount of the TAC in the hopper is measured and sent with measuring to a mixing tank. Then a necessary amount of the additive solution is sent from the additive tank to the mixing tank. Note that if the additive is in the liquid state in the room temperature, it may be fed in the liquid state to the mixing tank without preparing for the additive solution. Otherwise, if the additive is in the solid state in the room temperature, it may be fed in the solid state to the mixing tank with use of a hopper and the like. If plural sorts of additive compounds are used, the additive containing the plural additive compounds may be accumulated in the additive tank altogether. Otherwise plural additive tanks may be used so as to contain the respective additive compounds, which are sent through independent pipes to the mixing tank.

In the above explanation, the solvent, TAC, the additive are sequentially sent to the mixing tank. However, the sending order is not restricted in it. For example, after the necessary amount of TAC is sent with measurement to the mixing tank, the feeding of the preferable amount of the solvent may be performed. Further, it is not necessary that the additive is previously sent in the mixing tank, and they may be added to a mixture of TAC and the solvent.

The mixing tank is provided with a jacket covering over an outer surface of the mixing tank and first and second stirrer which are rotated by respective motors. The first stirrer preferably has an anchor blade, and the second stirrer is preferably an eccentric stirrer of a dissolver type. The inner temperature in the mixing tank is controlled with use of the heat transferring medium flowing in the jacket. The preferable inner temperature is in the range of −10° C. to 55° C. At least one of the first and second stirrers is adequately chosen for performing the rotation. Thus the swelling liquid in which TAC is swollen in the solvent is obtained.

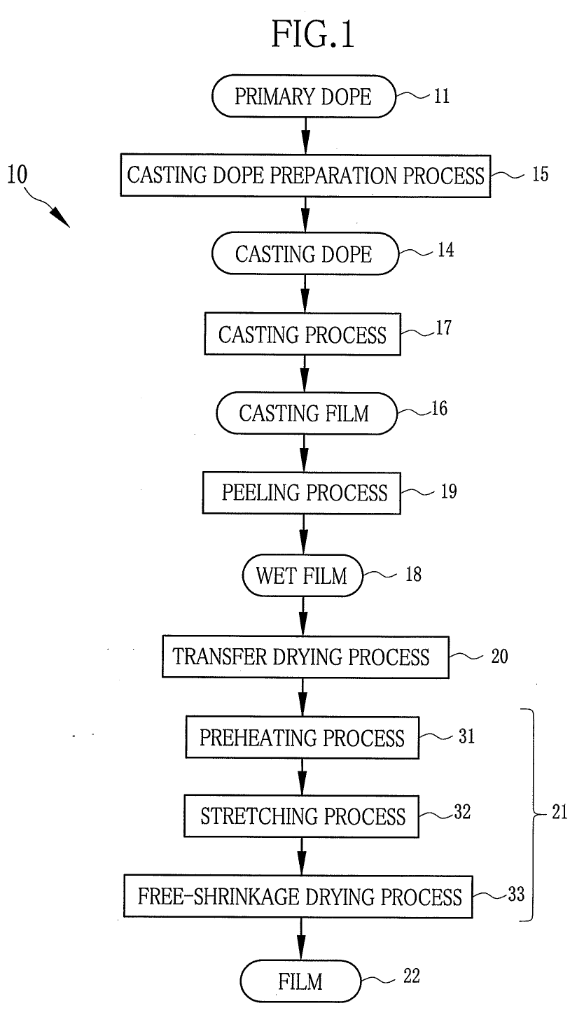

The swelling liquid in the mixing tank is sent with use of pump to a heating device. Preferably, the heating device is a pipe with a jacket, and further pressurizes the swelling liquid. During only the heating or both of the heating and pressurizing of the swelling liquid, the dissolution of TAC proceeds such that a polymer solution may be obtained. Note that the polymer solution may be a solution in which the polymer is entirely dissolved and a swelling liquid in which the polymer is swollen. It is to be noted in this heat-dissolution method, the temperature of the swelling liquid is preferably in the range of 50° C. to 120° C. Instead of the heat-dissolution with use of the heating device, the swelling liquid may be cooled in the range of −100° C. to −30° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution is fed to a temperature controlling device, so as to control the temperature nearly to the room temperature. Then the filtration of the polymer solution is made with a filtration device, such that impurities may be removed from the polymer solution. The filter used in the filtration device preferably has an averaged nominal diameter of at most 100 μm. The flow rate of the filtration in the filtration device is preferably at least 50 liter/hr. The polymer solution after the filtration is, as shown in FIG. 1, accumulated as a primary dope 11 (see, FIG. 2) in the stock tank 39 in the film production line 40.

The polymer solution can be used as a dope for a film production, which will be explained. However, in the method in which the dissolution of TAC is performed after the preparation of the swelling liquid, if it is designated that a polymer solution of high concentration is produced, the time for production of such dope becomes longer. Consequently, the production cost becomes higher. Therefore, it is preferable that a polymer solution of the lower concentration than the predetermined value is prepared at first and then the concentrating of the polymer solution is made. In this embodiment, the polymer solution after the filtration is sent to the flushing device. In the flushing device, the solvent of the polymer solution is partially evaporated. The solvent vapor generated in the evaporation is condensed by a condenser (not shown) to a liquid state, and recovered by a recovering device (not shown). The recovered solvent is recycled by a recycling device (not shown) and reused. According to this method, the decrease of cost can be designated, since the production efficiency becomes higher and the solvent is reused.

The polymer solution after the concentrating as the above description is extracted from the flushing device through a pump. Further, in order to remove bubbles generated in the polymer solution, it is preferable to perform the defoaming treatment. As a defoaming method, there are many methods which are already known, for example, an ultrasonic irradiation method and the like. Then the polymer solution is fed to another filtration device, in which the undissolved materials are removed. Note that the temperature of the polymer solution in the filtration is preferably in the range of 0° C. to 200° C. Thus the polymer solution is accumulated as the primary dope 11 (see, FIG. 2) in the stock tank 39.

Thus a dope is produced the produced dope has the TAC concentration in the range of 5 wt. % to 40 wt. %. The TAC concentration is preferably in the range of 15 wt. % to 30 wt. %, and especially 17 wt. % to 25 wt. %. Further, the concentration of the additive (mainly plasticizers) is in the range of 1 wt. % to 20 wt. %, if the total solid content in the dope is 100 wt. %.

Note that the method of producing the polymer solution is disclosed in detail in [0517] to [0616] in Japanese Patent Laid-Open Publication No. 2005-104148, for example, the dissolution method and the adding methods of the materials, the raw materials and the additive in the solution casting method for forming the TAC film, the filtering method, the bubble removing method, and the like.

(Film Producing Process)

Now, a film producing process 10 will be explained. As shown in FIG. 1, the film producing process 10 includes a casting dope preparation process 15 for preparing a casting dope 14 from the primary dope 11 obtained in the above method, a casting process 17 for casting the casting dope 14 onto the support so as to form a casting film 16, a peeling process 19 for peeling from the support the casting film 16 as a wet film 18 when the casting film 16 has a self-supporting property, and a transfer drying process 20 for stretching the wet film 18 with applying a drying air (now shown), and a tenter drying process 21 for drying the wet film 18 to a film 22. Note that there may be a film drying process for drying the film 22, a knurling process for providing a knurling for the film 22 and a film winding process for winding the film 22 may be performed.

(Tenter Drying Process)

The tenter drying process 21 includes a preheating process 31, a stretching process 32 and a free-shrinkage drying process 33. In the preheating process 31, the drying air whose conditions are controlled is applied to the wet film 18. The main object of the preheating process is to dry the wet film 18 by the preheating with reduction of the occurrence of the bowing.

In the stretching process 32 and the free-shrinkage drying process, the different sort of disorientations of optical axis occurs. In the free-shrinkage drying process 33 which is performed after the stretching process 32, a first disorientation of the optical axis is provided, and in the stretching process 32 which is performed before the free-shrinkage drying process 33, a second disorientation of the optical axis is provided.

In the stretching process 32, both side edge portions of the wet film 18 are held by holding members continuously running, and while the drying air is applied to the wet film 18, the stretching of the wet film 18 in a widthwise direction is made. In the stretching process 32, the stretching and the drying are made simultaneously with reducing the occurrence of the bowing, and the second disorientation of a optical axis is provided to the wet film with making the surface of the wet film smooth and adjusting or providing the optical properties such as the slow axis and the retardation value of the wet film 18.

In the free-shrinkage drying process 33, the wet film 18 is dried under the free-shrinkage in the widthwise direction. Thus the extending of the wet film 18 in the lengthwise direction is made with the non-stretching in the widthwise direction. The main object of the free-shrinkage drying process 33 is to provide the first disorientation of the optical axis for cancelling the second disorientation of the optical axis. Thus the second disorientation of the optical axis that has occurred by the bowing phenomena is cancelled.

Both side edge portions are held with the holding members and then move the holding members in a predetermined direction. Thus the bowing phenomena occur. In the bowing phenomena, the central area in the widthwise direction delays from both side edge portions. In the bowing phenomena, the shift of the central area is slower than shift of the both side edge portion, while the conveyance of the wet film 18 is made with the holding members holding both side edge portions. The delay of the central area occurs also when the tension applied to both side edge portions in the widthwise direction is released. The bowing phenomena of the wet film appear as the disorientation of the optical axis (namely the slow axis) in the produced film. In this specification, the disorientation of the optical axis that is caused by the delay of the central area in the wet film is described as the first disorientation. In the case that the first disorientation occurs, the central area forms a curve protruding in the upstream direction of the transporting direction.

Further, the disorientation of the optical axis that is caused by the delay of both side edge portions in the wet film is described as the second disorientation. In the case that the second disorientation occurs, the central area forms a curve protruding in the downstream direction of the transporting direction.

(Solution Casting Method)

In the followings, the film production line 40 for producing the film 22 from the primary dope 11 will be explained as an embodiment of the solution casting apparatus and the solution casting method of the present invention, in reference with FIG. 2. It is however to be noted that the present invention will not be restricted in FIG. 2. The film production line 40 includes the stock tank 39, a casting die 41, the back-up rollers 42, 43, a casting belt 44 as the support lapped over the back-up rollers 42, 43, a tenter drying chamber 45, an edge slitting device 46, a drying chamber 47, a cooling chamber 48, a winding chamber 49 and the like.

The stock tank 39 is provided with a motor 55 and a stirrer 56 to be rotated by the drive of the motor 55. The stock tank 39 is connected to the casting die 41 through a pipe 61 which has a pump 58, a filtration device 59 and a static mixer 60.

In the first tank 65, a matting agent liquid is stored. The matting agent liquid contains not only a matting agent but also an additive, the polymer and the solvent that are contained in the primary dope 11, so as to be mixed easily with the primary dope 11. The first tank 65 is connected to a pipe 67 on which a pump 66 is provided. In the present invention, the matting agent is not restricted. However, it is preferably silica gel, alumina and the like. Further, the concentration of the matting agent in the matting agent liquid is not restricted especially. However, it is preferably in the range of 0.01 wt. % to 0.50 wt. %.

In a second tank 70, a UV absorbing agent liquid is stored. The UV absorbing agent liquid contains not only a UV absorbing agent but also an additive, the polymer and the solvent that are contained in the primary dope 11, so as to be mixed easily with the primary dope 11. The second tank 70 is connected to a pipe 72 on which a pump 71 is provided, and the pipe 72 is connected to the pipe 67 through which the matting agent liquid is fed. Further, the pipe 67 is provided with a static mixer 74 in a downstream side from a connecting portion with the pipe 72. Note that the UV absorbing agent to be used in the present invention is not restricted especially. However, it is preferably benzotriazol type, benzophenone type and the like. Further, the concentration of the UV absorbing agent in the UV absorbing agent liquid is not restricted especially. However, it is preferably in the range of 0.1 wt. % to 3.0 wt. %.

The matting agent liquid is mixed with the UV absorbing agent liquid in the pipe 67, and thereafter, the mixture is stirred by the static mixer 74 to be uniform. Thus an additive solution is obtained.

The additive solution is fed into the pipe 61 in which the primary dope 11 is fed. Thus a mixture of the additive solution and the primary dope 11 is stirred by the static mixer 60 to be uniform. Thus the casting dope 14 is obtained.

The materials of the casting die 41 are preferably precipitation hardening stainless steel. The preferable material has coefficient of thermal expansion of at most 2×10⁻⁵ (° C.⁻¹). Further, the material to be used has an anti-corrosion property, which is almost the same as SUS316, in the examination of forcible corrosion in the electrolyte solution. Preferably, the materials to be used for the casting die 41 has such resistance of corrosion that the pitting doesn't occur on the gas-liquid interface even if the material is dipped in a mixture of dichloromethane, methanol and water for three months. The casting die 41 is preferably manufactured by performing the polishing after a month from the material casting. Thus the surface condition of the dope flowing in the casting die 41 is kept uniform. The finish precision of a contact face of the casting die to the casting dope 14 is at most 1 μm in surface roughness and at most 1 μm/m in straightness. The clearance of a slit of the casting die 41 is automatically adjustable in the range of 0.5 mm to 3.5 mm. According to an edge of the contact portion of a lip end of the casting die 41 to the dope, R(R is chamfered radius) is at most 50 μm in all of a width. Further, the shearing rate in the casting die 41 is controlled in the range of 1 to 5000 per second.

A width of the casting die 41 is not restricted especially. However, the width is preferably at least 1.1 times and at most 2.0 times as large as a film width. Further, a temperature controller is preferably attached to the casting die 41 so as to control the temperature of the casting die 41 to a predetermined value during the film production. Furthermore, the casting die 41 is preferably a coat hanger type die. Further, in order to adjust a film thickness, the casting die 41 is preferably provided with an automatic thickness adjusting device. For example, thickness adjusting bolts (heat bolts) are disposed at a predetermined distance in a widthwise direction of the casting die 41. According to the heat bolts, it is preferable that the profile is set on the basis of a predetermined program, depending on feed rate of the pump (preferably, high accuracy gear pump) 58, while the film production is performed. Further, the film production line 40 may be provided with a thickness meter (not shown), such as infrared ray thickness meter and the like. In this case, the feed back control of the adjustment value of the heat bolts may be made by the adjusting program on the base of the profile of the thickness meter. The thickness difference between any two points in the widthwise direction except the side edge portions in the casting film 16 is controlled preferably to at most 1 μm. The difference between the maximum and the minimum of the thickness in the widthwise direction is at most 3 μm, and especially at most 2 μm. Further, the accuracy to the designated object value of the thickness is preferably in ±1.5 μm.

Preferably, a hardened layer is preferably formed on a top of a lip end of the casting die 41. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and poor adhesiveness to the casting die 41. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of the casting dope 14 flowing on slit ends of the casting die 41, it is preferable to provide a solvent supplying device (not shown) at the slit ends, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts. wt., methanol 13 pts. wt., n-butanol 0.5 pts. wt.). The supply rate to each slit end is preferably in the range of 0.1 mL/min to 1.0 mL/min, in order to prevent the foreign materials from mixing into the casting film. Note that the pump for supplying the solvent has a pulse rate (or ripple factor) at most 5%.

The casting belt 44 is positioned below the casting die 41, and lapped on back-up rollers 42, 43. When the back-up rollers 42, 43 are rotated by the driving device (not shown), and thus the casting belt 44 runs endlessly in accordance with the rotation of the back-up rollers 42, 43. Then the casting speed is preferably in the range of 10 m/min to 200 m/min. Further, the temperatures of the back-up rollers 42, 43 are controlled by a heat transfer medium circulator 80 for cycling a heat transfer medium. It is preferable that the surface temperature of the casting belt 44 is adjusted in the range of −20° C. to 40° C. by heat transmission from the back-up rollers 42, 43. In this embodiment, paths (not shown) of the heat transfer mediums are formed in the back-up rollers 42, 43, and the heat transfer mediums whose temperatures are controlled by the heat transfer medium circulator 80 pass through the paths. Thus the temperature of the back-up rollers 42, 43 are kept to the predetermined values.

The width, the length and the material of the casting belt 44 are not restricted especially. However, it is preferably 1.1 to 2.0 times as large as the casting width. Preferably, the length is from 20 m to 200 m, and the thickness is from 0.5 mm to 2.5 mm. The surface is preferably polished so as to have a surface roughness at most 0.05 μm. The casting belt 44 is preferably made of stainless steel, and especially of SUS 316 so as to have enough resistance of corrosion and strength. The thickness unevenness of the entire casting belt 44 is preferably at most 0.5%.

Note that it is possible to use one of the back-up rollers 42, 43 as support. In this case, the back-up roller used as support is preferably rotated at high accuracy such that a rotation flutter may be at most 0.2 mm. Therefore the surface roughness is preferably at most 0.01 μm. Further, the chrome plating is preferably performed to the drum such that the drum may have enough hardness and endurance. As described above, it is preferable in the support that the surface defect must be reduced to be minimal. Concretely there are no pin hole of at least 30 μm, at most one pin hole in the range of 10 μm to 30 μm, and at most two pin holes of less than 10 μm per 1 m².

The casting die 41, the casting belt 44 and the like are included in a casting chamber 81. A temperature controlling device (not shown) is provided for controlling the inner temperature of the casting chamber 81 to the predetermined value, and a condenser 82 if provided for condensing organic solvent evaporated in the casting chamber 81. Further, outside the casting chamber 81, there is a recovering device 83 for recovering the condensed organic solvent. In this preferable embodiment, there is a decompression chamber 85 for controlling the pressure in the back side of a dope bead of the discharged casting dope. Thus the formation of the dope bead is stabilized.

In this embodiment, it is preferable to provide air ducts 87a, 87b, 87c for feeding a drying air for evaporating the solvent in the casting film 16 which is transported in accordance with the running of the casting belt 44. Further, an air shielding plate 87d is disposed close to the casting film 16 in the downstream side from the casting die 41. Although the drying wind causes to change surface conditions of the casting film 16 just after the formation, the air shielding plate 87d reduces the change of the surface conditions. Further, in the casting chamber, there is a passage for conveying the casting film 16 in accordance with the running of the casting belt 44. Close to the downstream passage, there is a roller 89 for peeling from the casting belt 44 the casting film 16 as the wet film 18. Then the wet film 18 is fed out from the casting chamber 81.

In the downstream side from the casting chamber 81, a transfer area 90 is provided. In the transfer area 90, there is an air blower 91 and at least one roller 92. The roller 92 guides the wet film 18 through the transfer area 90 toward the tenter drying chamber 45. If a plurality of the rollers 92 is used, the drying tension can be applied to the wet film 18 by making the rotation speed of the roller 92 in the downstream side faster.

The air blower 91 controls the conditions of the temperature, the moisture and the like in the transfer area 90 in predetermined ranges. Further, in the transfer area 90, there is a circulating device (not shown) for circulating the air in the transfer area 90. Thus the air in the transfer area becomes uniform. The temperature of the drying air is preferably in the range of 20° C. to 250° C. Thus the degree of the progression of drying the wet film 18 passing through the transfer area 90 and the temperature of the wet film 18 become to predetermined values.

In the tenter drying chamber 45, the tenter drying process 21 is performed to the wet film 18, and the wet film 18 is fed out as the film 22 from the tetner drying chamber 45. Then the film 22 is fed to the edge slitting device 46 which is disposed downstream from the tenter drying chamber 45. In the edge slitting device 46, both side edge portions of the film 22 is slit off. Tips of the slit side edge portions of the film 22 are crushed by a crusher 93 which is connected to the edge slitting device 46. The detailed explanation of the tenter drying chamber will be made later.

The drying chamber 47 incorporates many rollers 100. Further to the drying chamber 47 is attached an adsorbing device 101 for adsorbing and recovering the solvent vapor which is generated in the evaporation of the solvent from the film 22. Further, in a downstream from the drying chamber 47, there is the cooling chamber 48 for cooling the film 22. Furthermore, a humidity control chamber (not shown) may be provided for conditioning the humidity between the dying chamber and the cooling chamber 48.

In the downstream side from the drying chamber 47, a compulsory neutralization device (or neutralization bar) 102 eliminates the charged electrostatic potential of the film 22 to the predetermined value (for example, in the range of −3 kV to +3 kV). The position of the neutralization process is not restricted in this embodiment. For example, the position may be a predetermined position in the drying section or in the downstream side from a knurling roller 103, and otherwise, the neutralization may be made at plural positions. After the neutralization, the embossing of both side portions of the film 22 is made by the embossing rollers to provide the knurling. Further, in the winding chamber 49, there are a winding shaft 110 for winding the film 22 and a press roller 111 for controlling the tension of the film in the winding.

<Tenter Drying Chamber>

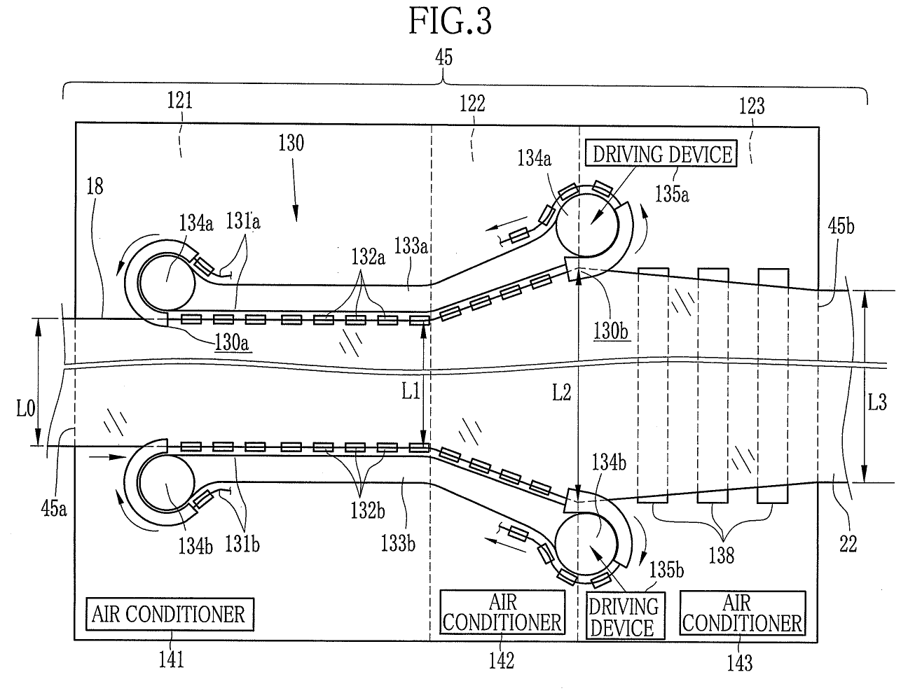

The detailed explanation of the tenter drying chamber 45 will be made now. In FIG. 3, the tenter drying chamber 45 has first-third zones 121-123. The first zone 121 is positioned in the most upstream side, and then the second zone 122 follows to the first zone 121 in the transfer direction of the wet film 18. Then the third zone 123 is positioned next the second zone 122. And the free-shrinkage drying process 33 is performed in the third zone 123.

<Tenter Device>

In the tenter drying chamber 45, there is a tenter device 130 including a pair of endless chains 131a, 131b for running continuously, clips 132a, 132b as holding members of the wet film 18, guide rails 133a, 133b for guiding the running chains 131a, 131b, chain sprockets 134a, 134b on which the chains 131a, 131b are wound, driving devices 135a, 135b for driving the chain sprockets 134a, 134b respectively. The clips 132a, 132b are respectively attached to the chains 131a, 131b at a predetermined interval. Therefore, if the driving devices 135a, 135b are driven to run the chains 131a, 131b, the clips 132a, 132b move on the rails 133a, 133b at a predetermined speed. Further, the tenter device 130 has a clipping position 130a and a releasing position 130b. The clipping position 130a is positioned in the first zone 121, and the releasing position 130b is positioned so as form a border between the second zone 122 and the third zone 123. In the clipping position 130a, the clips 132a, 132b clip both side edge portions of the wet film 18. In accordance with the running of the clips 132a, 132b, the wet film 18 is transported from the clipping position 130a to the releasing position 130b. In the releasing position 130b, both side edge portions are released from the clips 132a, 132b. The driving devices 135a, 135b may be disposed in the clipping position 130a or the releasing position 130b. For example, if the driving devices 135a, 135b are disposed in the clipping position 130a, the chain sprockets 134a, 134b in the clipping position 130a is rotated. However, the position of the driving devices 135a, 135b is not restricted especially.

In the downstream side from the releasing position 130b, there are rollers 138 for guiding the wet film 18 in the third zone 123 to the edge slitting device 46. In the third zone 123, a draw tension is applied to the wet film 18 in the lengthwise direction by making the rotation speed of the rollers 138 in the downstream side faster than in the upstream side. Thus the extension of the wet film 18 in the lengthwise direction is made.

The first-third zones 121-123 respectively has air conditioners 141-143 for controlling air conditions, for example the temperature and the moisture, in the first-third zones 121-123 in a predetermined range. Further, in each first-third zone 121-123, there is a circulator (not shown) for circulating the inner air. Thus the inner air in each first-third zone 121-123 becomes uniform. Thus the degree of the progression of drying the wet film passing through the first-third zones 121-123 and the temperature of the wet film 18 become to predetermined value.

At the clipping position 130a of the tenter device 130 in the first zone 121, both side edge portions of the wet film 18 are clipped by the clips 132a, 132b, and transported from the first zone 121 to the third zone 123. During the transport of the wet film 18, the air conditioners 141-143 and the driving devices 135a-135b keep the temperature and the moisture in the first-third zones 121-123 to the predetermined values, and thus the drying of the wet film 18 is made such that the content of the remaining solvent may be a predetermined range. At the releasing position 130b, both side edge portions of the wet film 18 is released from the clips 132a, 132b, and thereafter the wet film 18 is transported through the third zone 123 with the drying under a predetermined condition. Then the wet film 18 is fed out as the film 22 from the tenter drying chamber 45 and transported to the edge slitting device 46.

The rails 133a, 133b are disposed such that the interval between them may gradually change through the first-third zones 121-123, and thus the interval becomes to a predetermined value in the third zone 123. In this figure, the rails 133a, 133b are disposed such that the width of the wet film 18 may be L1 on the borderline between the first and second zone 121, 122, and L2 on the borderline between the second and third zone 122, 123. Note that a machine for changing the interval between the rails is explained in detail in Japanese Patent Laid-Open Publication No. 2003-276082.

Thus the stretch, the relaxation, and the drying are performed in steps while transported in the tenter drying chamber 45. The stretch means the stretching of the wet film 18 in the widthwise direction. Further, the relaxation means the relaxation of the wet film 18 in the widthwise direction by extending the wet film 18 in the lengthwise direction.

Note that the ratio of the stretch and the relaxation in the tenter drying chamber 45 is a value calculated from L(X)/L(X−1) if L(X) is a width of the wet film 18 at the most downstream position and L(X−1) is that of the wet film 18 at the most upstream position. in each of the first-third zones 121-123 In the stretch, the value of the L(X)/L(X−1) is more than 1, and in the relaxation, the value is less than 1. Further, L0 is a width of the wet film 18 at the entrance 45a of the tenter drying chamber 45, and L3 is a width of the wet film 18 at the exit 45b of the tenter drying chamber 45.

An embodiment of the film production method for producing the film 22 with use of the film production line 40 will be described now. The primary dope 11 is always made uniform by the rotation of the stirrer 56. The additives such as the plasticizer and the like may be added during the stirring.

The pump 58 is driven to feed the primary dope 11 to the filtration device 59, in which the filtration of the primary dope 11 is made. The matting agent liquid and the UV absorbing agent liquid are mixed in a pipe (not shown), and the mixing thereof is made by a static mixer (not shown) to be a uniform additive liquid. Then the additive liquid is added to the primary dope 11 fed in the pipe 61 (see, FIG. 1). Thereafter, the mixing of the primary dope 11 with the additive liquid is made by the static mixer 60, and the primary dope 11 becomes uniform and is fed out as the casting dope 14 from the static mixer 60. The mixing ratio between the primary dope 11, the matting agent liquid and the UV absorbing agent is not restricted especially. However, it is preferable that the ratio of the weight percentages (the primary dope 11, the matting agent liquid and the UV absorbing agent) is from (90 wt. %; 5 wt %; 5 wt. %) to (99 wt. %; 0.5 wt. %; 0.5 wt. %).

The drive of the back-up rollers 42, 43 is preferably controlled such that a tension of the casting belt 44 may be in the range of 104 N/m to 105 N/m. Thereafter, the casting dope 14 is cast from the casting die 41 onto the casting belt 44. The relative speed difference between the casting belt 44 and each back-up roller 42, 43 is at most 0.01 m/min. According to the control of the casting belt 44, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the casting belt 44, so as to make a feed-back control of the position of the casting belt 44 on the basis of measured values. Furthermore, the position of the casting belt 44 shifts up- and downwardly in accordance with the rotation of the back-up roller 42. Therefore, it is preferable that the position of the casting belt 44 is preferably controlled just below the casting die 41, such that a shift range of the casting belt 44 may be at most 200 μm. The inner temperature of the casting chamber 81 is preferably controlled in the range of −10° C. to 57° C. by the temperature controlling device (not shown). The solvent vapor in the casting chamber 81 is condensed by the condenser 82, and the recovered solvent was recovered by the recovering device 67 and then recycled as a solvent for the dope preparation.

The casting dope 14 is discharged through the outlet 41a of the casting die 41. Between the casting die 41 and the casting belt 44, a bead of the discharged dope forms a bead, and the cast dope forms the casting film 16 on the casting belt 44. Preferably, the temperature of the casting dope 14 is in the range of −10° C. to 57° C. Further, in order to stabilize the formation of a bead of the cast dope, there is the decompression chamber 85 for controlling the pressure in the back side of the dope bead. The decompression is preferably made such that the pressure difference of an upstream to a downstream side from the dope bead may be in the range of 10 Pa to 2000 Pa.

It is preferable to provide the decompression chamber 85 with a jacket (not shown) for controlling the inner temperature. The temperature of the decompression chamber 85 is not restricted especially. However, the temperature is preferably at least the highest melting point of the used organic solvent materials. Further, aspirators (not shown) may be provided with the decompression chamber 85 so as to be near both side edges of a dope outlet of the casting die 41. Thus the aspiration in both side edges of the dope bead is made to stabilize the shape of the dope bead. In this case, the force velocity of the aspiration is preferably in the range of one to one hundred liter/min.

The air ducts 87a-87c feed a wind such that the solvent in the casting film 16 may evaporate more. In this case, although the application of the drying air cause to change surface conditions of the casting film 16 just after the formation, the air shielding plate 87d reduces the change of the surface conditions. The surface temperature of the casting belt 44 is preferably in the range of −20° C. to 40° C.

When the cast dope has self-supporting property, the casting film 16 is peeled as the wet film 18 with support of the roller 89. The content of the remaining solvent at the peeling is preferably in the range of 20 wt. % to 250 wt. % to the content of the solid materials. Then the wet film 18 is transported in the transfer area 90 in which many rollers are provided. In the transfer area 90, the air blower 91 feeds a drying air whose temperature is a predetermined value. Thus the drying of the wet film 18 proceeds. In the transfer area 90, the rotation speed of each roller becomes higher in the upstream side. Thus the draw tension can be applied to the wet film 18 in the transporting direction.

About the content of the remaining solvent, it was necessary to sample and dry part of the casting film 16, the wet film 18 or the film 22. If the sample weight at the sampling was x and the sample weight after the drying was y, the solvent content on the dry basis was calculated in the formula, {(x−y)/y}×100.

In the tenter drying chamber 45, both side edge portions of the wet film 18 are held by the clips 132a, 132b at the clipping position 130a, and the wet film 18 is transported from the first zone 121 to the second zone 122 in accordance with the moving of the clips 132a, 132b on the rails 133a, 133b. Thereafter, on the border line between the second zone 122 and the third zone 123, both side edge portion is released from the clips 132a, 132b. Then the wet film 18 is transported by rollers (not shown) toward the crusher 93 under a predetermined condition. Note that the drying of the wet film 18 in the tenter drying chamber 45 will be explained in detail later.

The wet film 18 is dried until the content of the remaining solvent become the predetermined value, and fed out as the film 22 from the tenter drying chamber 45 toward the edge slitting device 46 for slitting off both side edge portions. The slit side edge portions are sent to the crusher 93 by a cutter blower (not shown), and crushed to tips by the crusher 93. The tips are reused for preparing the dope, which is effective in view of the decrease of the production cost. Note that the slitting process of both side edge portions may be omitted. However, it is preferable to perform the slitting between the casting process and the winding process.

The film 22 whose side edge portions are slit off is sent to the drying chamber 47 and dried furthermore. In the drying chamber 47, the film 22 is transported with lapping on rollers 100. The inner temperature of the drying chamber 47 is not restricted especially. However, it is preferable in the range of 50° C. to 160° C. The solvent vapor evaporated from the film 22 by the drying chamber 47 is adsorbed by the adsorbing device 101. The air from which the solvent components are removed is reused for the drying air in the drying chamber 47. Note that the drying chamber 47 preferably has plural partitions for variation of the drying temperature. Further, a pre-drying device (not shown) is provided between the edge slitting device 46 and the drying chamber 47, so as to perform the pre-drying of the film 22. Thus it is prevented that the temperature of the film 22 increases rapidly, and therefore the change of the shape of the film 22 is reduced.

The film 22 is transported toward the cooling chamber 48, and cooled therein to around the room temperature. A humidity control chamber (not shown) may be provided for conditioning the humidity between the drying chamber 47 and the cooling chamber 48. Preferably, in the humidity control chamber, an air whose temperature and humidity are controlled is applied to the film 22. Thus the curling of the film 22 and the winding defect in the winding process can be reduced.

Thereafter, the compulsory neutralization device (or neutralization bar) 102 eliminates the charged electrostatic potential of the film 22 to the predetermined value (for example, in the range of −3 kV to +3 kV). The position of the neutralization process is not restricted in this embodiment. For example, the position may be a predetermined position in the drying section or in the downstream side from the knurling roller 103, and otherwise, the neutralization may be made at plural positions. After the neutralization, the embossing of both side portions of the film 22 is made by the embossing rollers to provide the knurling. The emboss height from the bottom to the top of the embossment is in the range of 1 μm to 200 μm.

In the last process, the film 22 is wound by the winding shaft 110 in the winding chamber 49. At this moment, a tension is applied at the predetermined value to the press roller 111. Preferably, the tension is gradually changed from the start to the end of the winding. In the present invention, the length of the film 22 is preferably at least 100 μm. The width of the film is preferably at least 600 mm, and particularly in the range of 1400 mm to 1800 mm. Further, even if the width is more than 1800 mm, the present invention is effective. Even if the thickness is in the range of 15 μm to 100 μm, the present invention can be applied.

In followings, the detailed explanation of the wet film 18 in the tenter drying chamber 45 will be made.

As shown in FIG. 3, after the wet film 18 enters through the entrance 45a into the tenter drying chamber 45, the clips 132a, 132b clip both side edge portions of the wet film 18 at the clipping position 130a. In accordance with the movement of the chain 131a, 131b, the wet film 18 is fed from the clipping position 130 toward the releasing position 130b. At the releasing position 130b, the clips 132a, 132b releases both side edge portions of the wet film 18 from being clipped. Then the wet film 18 is conveyed through the third zone toward the exit 45b. Thus the wet film 18 is sequentially conveyed from the first zone 121 to the third zone 123. Thereafter wet film 18 is fed out as the film 22 from the tenter drying chamber 45, and the film 22 is transported by a roller (not shown) toward the edge slitting device 46.

The air conditioners 141-143 respectively control the conditions of the airs in the first-third zones 121-123. In this embodiment, the conditions of the air in the first-third zones 121-123 are the temperatures T1-T3, the moistures, and the vapor pressure of the solvent.

<First Zone>

In the first zone 121, the preheating process is made as the preparation process for the drying in each of the second and third zones 122, 123. In the first zone 121, the temperature T1 and the content Z1 of the remaining solvent in the wet film 18 may be adjusted in accordance with the temperature T2 and the content Z2 in the second zone 122. The concrete explanation about the temperature T1 and the content Z1 in the first zone 121 will be explained later.

<Second Zone>

In the second zone 122, the stretching process 32 is made, so as not only to adjust the retardation of the wet film 18 and make the surface of the wet film 18 smooth but also to provide the second disorientation of the optical axis to the wet film 18. In the second zone 122, the magnitude L2/L1 of the stretching process 32 is preferably at least 101% and less than 120%. When the stretching is made so as to satisfy the condition, the second disorientation of the optical axis can be adequately provide to the wet film 18. If the value L2/L1 is less than 100%, it is difficult to make the smoothing of the film surface enough. If the value L2/L1 is at least 121%, the second disorientation of the optical axis becomes too large to cancel the first disorientation of the optical axis adequately in the relaxation drying process which follows to the stretching process 32. Further, in this case, the stretch is made more over, the wet film 18 is sometimes torn.

In the second zone 122, the content Z2 of the remaining solvent in the wet film 18 is preferably in the range of 5 wt. % to 10 wt. %. Preferably, the temperature T2 of the wet film 18 is the same as or more than the glass transition temperature Tg (° C.) of the polymer. If the temperature T2 is less than the glass transition temperature Tg, it is difficult to provide the second disorientation of the optical axis to the wet film 18, and it is not preferable. Further, if the main polymer content in the wet film 18 is cellulose acylate, the temperature of the wet film 18 which satisfies the above conditions of the content Z2 of the remaining solvent is preferably in the range of 95° C. to 130° C.

<Third Zone>

In the third zone 123, the free-shrinkage drying process 33 is performed to the wet film 18. In the third zone 123, both side edge portions of the wet film 18 is released from the clipping by the clips 132a, 132b, and therefore the residual stress generated in the wet film 18 by the stretching is reduced by the relaxation. Further, since the wet film 18 is guided by the rollers 138 whose rotation speeds are different, the wet film 18 is extended in the lengthwise direction. By performing both of the relaxation and the extension of the wet film 18, the first disorientation of the optical axis occurs in the wet film 18. However, before the wet film 18 is conveyed into the third zone 123, the second disorientation of the optical axis is provided. Therefore, in the third zone 123, when the first disorientation of the optical axis occurs, the wet film 18 is provided with the first and second disorientations of the optical axis, and the disorientations are cancelled each other by the combination thereof in the wet film 18.

The magnitude L3/L2 may be set such that the first and second disorientations of the optical axes may cancel each other. However, the stretching in the third zone 123 has not to damage the optical property and the surface smoothness of the wet film 18 while the optical property and the surface smoothness are adjusted in the second zone 122. In this embodiment, the magnitude of the relaxation in the third zone 123 is preferably at least 90% and less than 100%. In this case, the second disorientation of the optical axis occurs in the wet film 18 so as to cancel the first disorientation of the optical axis. If the value L3/L2 is more than 100%, it is very easy not only to provide the second disorientation of the optical axis to the wet film 18, but also to sometimes damage the optical property and the surface smoothness of the wet film 18. Furthermore, if the value L3/L2 is more than 100%, the extension of the wet film 18 in the lengthwise direction is not made enough, and therefore the wet film 18 sometimes tears.

Further, the adjustment of the magnitude L3/L2 can be adjusted in accordance with the rotation speed of the roller 138.

In the third zone 123, the content Z3 of the remaining solvent in the wet film 18 is preferably at most 5 wt. %, and the temperature T3 of the wet film 18 is preferably in the range of 10° C. to 200° C. If the temperature T3 is less than 10° C., the drying of the wet film 18 is not made enough, and it is difficult to provide the second disorientation of the optical axis.

Thus when the wet film 18 passes through the third zone 123, the first disorientation cancels the second disorientation, and therefore the disorientations in the wet film 18 is totally cancelled. Thus the effect of the disorientation of the optical axis is reduced, and the random disorientation of the slow axis becomes smaller. In this situation, the wet film 18 is fed out as the film 22 toward the edge slitting device 46.

<Reduction of Bowing>

Further, if the temperature of the wet film 18 is adjusted in accordance with the content of the remaining solvent in the wet film 18 under the satisfaction of the above conditions, it is prevented that the bowing on the wet film 18 occurs in the tenter drying process 21. The conditions of the adjustment will be described in followings, although they are applied not only to the transfer drying process 20 but also to the tenter drying process 21.

First, if the content of the remaining solvent in the wet film 18 is in the range of 30 wt. % to 60 wt. % (hereinafter the first range), the vaporization heat generating by the evaporation of the solvent has a large efficiency to the wet film 18, and the wet film 18 shrinks, which causes the bowing. In order to prevent the bowing caused by the shrinkage, it is preferable to kept the temperature of the wet film 18 in the first range is in the range of 60° C. to 80° C. If the temperature is less than 60° C., the drying of the wet film 18 cannot be made enough. If the temperature is more than 80° C., the drying of the wet film 18 is made quickly, which causes the nonuniformity of the elastic modules, and therefore the bowing phenomena occurs.

Secondly, if the content of the remaining solvent in the wet film 18 is in the range of 8 wt. % to 30 wt. % (hereinafter the second range), the content of the remaining solvent decreases by the drying in the second zone 122, which increases the interaction between the polymer molecules in the wet film 18. In order to reduce the generation of the bowing by the stretch, it is preferable to kept the temperature of the wet film 18 in the second range is in the range of 95° C. to 110° C. In this case, the interaction between the molecule becomes maximal, and therefore the generation of the disorientation during the stretching is reduced in effect of the enlargement of the interaction.

Thirdly, if the content of the remaining solvent in the wet film 18 is in the range of 5 wt. % to 8 wt. % (hereinafter the third range), the temperature of the wet film is preferably in the range of 100° C. to 120° C. If the temperature of the wet film 18 in the third range is less than 100° C., the drying of the wet film 18 cannot be made. Further, if the temperature of the wet film 18 in the third range is more than 120° C., the temperature is higher than the glass transition temperature Tg of the polymer, and therefore the wet film becomes soft, which cause the bowing phenomena. Therefore, in order to stretch the wet film 18 in the third range, a predetermined value of the second disorientation of the optical axis is provided for the wet film 18 by adjusting the temperature and the stretch magnitude of the wet film 18.

In the present invention, the tenter drying process 21 can be made during reducing the disarrangement of the slow axis of the wet film 18, while the disarrangement is caused by the bowing phenomena. Therefore, since the retardation adjustment and the surface smoothing are made and the erratic pattern of the slow axis is reduced, the film to be produced in the present invention is excellent in the optical property and used therefore as the optical film. Further, since the tenter drying process 21 can be applied to the tenter drying chamber 45 and the tenter device 130, the production cost is reduced, and the produced film is excellent in the optical property.

In the present invention, in order to cancel the disorientation of the optical axis that occurs in the film production, the free-shrinkage drying process 33 is performed not in the tenter device but during the transport of the wet film 18 with use of the roller 138. In the present invention, the space for the film production in which the effect of the disorientation of the optical axis can be smaller than in the case that the cancelling of the disorientation is processed in the tenter device 130. Therefore, in the present invention, the free-shrinkage drying process 33 is performed easily, in accordance with the largeness of the second disorientation of the optical axis.

In the first-third zones 121-123, the contents Z1-Z3 can be respectively adjusted in accordance with the conditions of the air blows fed from the air conditioners 141-143 and the transporting speed of the wet film 18. In order to control the transfer speed of the wet film 18 in a predetermined range, the moving speed of the clips 132a, 132b is controlled by the driving devices 135a, 135b. Further, in the first-third zones 121-123, the method of adjusting the conditions of the atmosphere the air conditioners 141-143 is not restricted in the above explanation, namely the adjustment is made on the basis of the predetermined adjustment conditions. For example, the air blow whose conditions are adjusted to the predetermined adjustment conditions is applied directly to the wet film 18. In this case, it is preferable that the blowing speed and the humidity of the air blow fed out from the air conditioners 141-143 are also regarded as the predetermined adjustment conditions for the drying of the wet film. Further, a decompression device (not shown) may be used for controlling the pressure of the atmosphere around the wet film which passes through the first-third zones 121-123. The decompression chamber may be used with the air conditioners 141-143 for controlling the progress of the drying of the wet film 18.

In this embodiment, the contents Z1-Z3 of remaining solvents in the wet film 18 in the first-third zones 121-123 are determined by the predetermined drying conditions obtained from the production experiment which is performed by adjusting the air blow conditions of the air conditioners, the transferring speed of the wet film 18, the length of each rail 133a, 133b, and the like. Further, the content of the remaining solvent is measured from the weight of a unit size of the wet film 18 in each process and the film produced in the experiment.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the dope bead between a die slit (or die lip) and the support that the composition of alcohol is higher in the two outer dopes than the inner dope.

Further, the polymer to be used in the present invention is not restricted in cellulose acylate, and may be also cellulose alkylate, CAP (cellulose acetate propionate), CAB (Cellulose acetate butylate), PET, polyethylene and the like. Thus, when the polymer other than the cellulose acylate is used, the temperature of the wet film 18 explained in the above embodiment may be determined in accordance with the glass transition temperature Tg, the interaction between the molecules and the like.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

### EXPERIMENT

The experiment of the present invention was made, whose explanation will be made in followings. In this experiment, five examples of the film production were performed. Examples 1 & 2 were the examples of the present invention, and Examples 3-5 were the comparisons to Examples 1 & 2. The explanation of Example 1 will be made in detail, and the explanation of the same things in the explanations of Examples 2-5 will be omitted.

### Example 1

The explanation of Example 1 is made now. The compositions for the preparation of the dope to be used for the film production were as follows:

<Solid Compounds>

| | | |
|---|---|---|
| Cellulose Triacetate (Degree of substitution, 2.8) | 89.3 | wt. % |
| Plasticizer A (triphenyl phosphate) | 7.1 | wt. % |
| Plasticizer B (biphenyldiphenyl phosphate) | 3.6 | wt. % |

<Solvent>

| | | |
|---|---|---|
| Dichloromethane (first component of solvent) | 92 | wt. % |
| Methanol (second component of solvent) | 8 | wt. % |

The solvent for the dope contained the first and second components of solvent, as described above. The solid compounds were added to the solvent adequately, such that the primary dope 11 was obtained. Note that the solid content in the obtained primary dope 11 were 19.3 wt. %. Then the primary dope 11 was filtrated with use of a filter (#63LB, produced by Toyo Roshi Kaisha, Ltd.), and further filtrated with use of a sintered metallic filter (06N, porous diameter 10 μm, produced by Nippon Seisen, Co., Ltd.). Furthermore, the primary dope 11 was filtrated with use of a mesh filter, and then stored in the stock tank 39.

<Cellulosetriacetate>

According to cellulose triacetate used in this experiment, the remaining content of acetic acid was at most 0.1 wt. %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 wt. %, and a ratio of weight-average molecular weight to number-average molecular weight was 2.5. Further, yellow index was 1.7, haze was 0.08, and transparency was 93.5%. This cellulose triacetate is synthesized from cellulose as material obtained from cotton, and called cotton TAC in the following explanation.

<Preparation for Liquid of Matting Agent>

The matting agent liquid was prepared so as to contain the following compound, while the TAC was the same as that for the preparation of the primary dope 11:

| | | |
|---|---|---|
| Silica | 0.67 | wt. % |
| (Aerosil R972, produced by Nippon Aerosil Co., Ltd.) | | |
| Cellulose triacetate | 2.93 | wt. % |
| Triphenyl phosphate | 0.23 | wt. % |
| Biphenyldiphenyl phosphate | 0.12 | wt. % |
| Dichloromethane | 88.37 | wt. % |
| Methanol | 7.68 | wt. % |

The dispersion of the mixture of the above compounds was made with use of the attritor such that the average particle diameter in volume might be 0.7 μm. Thus the liquid of matting agent was prepared and then filtered with use of Astropore filter (produced by Fuji Photo Film Co., LTD.), and then stored in the matting agent tank.

<Preparation for Liquid of UV Absorbing Agent>

| | | |
|---|---|---|
| UV-agent A | 5.83 | wt. % |
| (2(2′-hydroxy-3′,5′-di-tert- | | |
| butylphenyl)-5-chlorobenzotriazol) | | |
| UV-agent B | 11.66 | wt. % |
| (2(2′-hydroxy-3′,5′-di-tert- | | |
| amylphenyl)benzotriazol) | | |
| Cellulose triacetate | 1.48 | wt. % |
| Triphenyl phosphate | 0.12 | wt. % |
| Biphenyldiphenyl phosphate | 0.06 | wt. % |
| Dichloromethane | 74.38 | wt. % |
| Methanol | 6.47 | wt. % |

The prepared liquid of UV absorbing agent was filtered with use of Astropore filter (produced by Fuji Photo Film Co., LTD.), and then stored in the UV agent tank.

Further, a mixture solvent A was prepared so as to contain 86.5 pts. wt. of dichloromethane, 13 pts. wt. of methanol, 0.5 pts. wt. of 1-butanol.

The liquid of matting agent was added to the liquid of UV absorbing agent, and the mixture was stirred by a static mixer, such that the additive liquid was obtained. The pump 58 was driven to feed the primary dope 11 through the pipe 61, and the primary dope 11 was filtrated by the filtration device 59. Then the additive liquid was added to the primary dope 11, and the mixing of the primary dope 11 and the additive liquid was made by the static mixer 60. Thus the casting dope 14 was obtained.

The film 22 was produced with use of the film production line 40 shown in FIG. 2. The pump 58 increases the pressure in the primary side, and the primary dope 11 was fed with a feed back control to the upstream side from the pump with use of an inverter motor, such that the pressure in the primary side may be 0.8 MPa. As for the efficiencies of the pump 58, the volume efficiency was at most 99.2%, fluctuation percentage of the discharge volume was at most 0.5%. Further, the pressure for discharging was 1.5 MPa.

The casting dope 14 was cast from the casting die 41 with the adjustment of the casting ratio of the casting dope 14, such that the formed casting film might be 1.8 m in width and the dried film might be 80 μm in width. Further the casting width of the casting dope 14 from the outlet 41a of the casting die 41 was 1700 mm. The casting speed was in the range of 45 m/min to 55 m/min. The temperature of a heat transfer medium was controlled to 36° C. at the entrance of the jacket, such that the temperature of the casting dope 14 may be controlled to 36° C.

The temperatures of casting die 41 and the pipe were controlled to 36° C. during the film production. The casting die 41 was the coat hunger type, in which heat bolts for adjusting the film thickness were disposed at the pitch of 20 mm. Thus the film thickness (or the thickness of the dopes) is automatically controlled by the heat bolt. A profile of the heat volt can be set corresponding to the flow rate of a pump (not shown), on the basis of the preset program. Thus the feed back control can be made by the control program on the basis of the profile of an infrared ray thickness meter (not shown) disposed in the film production line 40. The control was made such that, with exception of both side edge portions (20 mm each in the widthwise direction of the produced film), the difference of the film thickness between two positions (50 mm apart from each other) might be at most 1 μm, and the largest difference between the minimal values of the film thickness in the widthwise direction might be at most 3 μm/m. Further, the average film thickness might was controlled in ±1.5%.

The primary side (namely the upstream side) of the casting die 41 is provided with the decompression chamber 85. The decompression rate of the decompression chamber 85 was controlled in accordance with the casting speed, such that the pressure difference might occur in the range of one Pa to 5000 Pa between the upstream and downstream sides of the dope bead of the discharged casting dope above the casting belt 44. At this time, the pressure difference between both sides of the dope bead was determined such that the length of the dope bead might be from 20 mm to 50 mm. Further, an instrument was provided such that the temperature of the decompression chamber 85 might be set to be higher than the condensation temperature of the gas around the casting section. Further, there was labyrinth packing (not shown) in the upstream and downstream sides of the dope beads.

The material of the casting die 41 was the stainless steel, whose coefficient of thermal expansion was at most 2×10⁻⁵ (° C.⁻¹). In the compulsory corrosion experiment in an electrolyte solution, the corrosion resistance was almost the same as that of SUS316. Further, the material to be used for the casting die 41 had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die to the casting dope 14 was at most 1 μm in surface roughness, and the slit clearance was adjusted to 1.5 mm in straightness. According to an edge of the contact portion of a lip end of the casting die 41, R is at most 50 μm in all of a width. Further, the shearing rate in the casting die 41 controlled in the range of one to 5000 per second. Further, the WC (tungsten carbide) coating was made on the lip end from the casting die 41 by a melt extrusion method, so as to provide the hardened layer.

In order to prevent the dry and solidification on part of the slit end of the casting die 41, the mixture solvent A dissolvable of the solidified dope was supplied to each edge portion of the gas-liquid interface of the slit at 0.5 ml/min. Thus the mixture solvent is supplied to each bead edge. The pulse rate of a pump for supplying the mixture solvent was at most 5%. Further, the decompression chamber 68 was provided for decreasing the pressure in the rear side by 150 Pa. In order to control the temperature of the decompression chamber 68, a jacket (not shown) was provided, and a heat transfer medium whose temperature was controlled at 35° C. was supplied into the jacket. The edge suction rate could be controlled in the range of 1 L/min to 100 L/min, and was adequately controlled in this experiment so as to be in the range of 30 L/min to 40 L/min.

The casting belt 44 was a stainless belt which was 1.9 m in width and 70 m in length. The thickness of the casting belt 44 was 1.5 mm, and the surface of the casting belt 44 was polished, such that the surface roughness might be at most 0.05 μm. The material was SUS316, which had enough corrosion resistance and strength. The thickness unevenness of the entire casting belt 44 was at most 0.5% of the predetermined value. The casting belt 44 was moved by rotating the back-up rollers 42, 43. In this experiment, the control was made such that the difference of the relative speed of the casting belt 44 to the back-up rollers 42, 43 was at most 0.01 m/min. Further the control was made such that the variation of the speed of the casting belt 44 was at most 0.5% to the predetermined value. The position of the belt in the widthwise direction was controlled with detection of the position of the side end, such that meandering in one circle of the casting belt 44 which is running was reduced in 1.5 mm. Further, below the casting die 41, the variation of the position in the vertical direction between the lip end of the casting die 41 and the casting belt 44 was in 200 μm.

In this experiment, the back-up rollers 42, 43 were supplied therein with a heat transfer medium, such that the temperature of the casting belt 44 might be controlled. The back-up roller 43 disposed in a side of the casting die 41 was supplied with the heat transfer medium (water) at 5° C., and the back-up roller 42 was supplied with the heat transfer medium (water) at 40° C. The surface temperature of the middle portion of the casting belt 44 at a position just before the casting was 15° C., and the temperature difference between both sides of the belt was at most 6° C. Note that a number of pinhole (diameter, at least 30 μm) was zero, a number of pinhole (diameter, at least 10 μm and less than 30 μm) was at most one in square meter, and a number of pinhole (diameter, less than 10 μm) was at most two in square meter.

At first, the drying air was fed out in parallel to the casting film 16 so as to make the drying. Further, the drying air at 140° C. was fed out from the upstream air duct 87a to dry the casting film 16, the drying air at 140° C. was fed out from the downstream air duct 87b to dry the casting film 16, and the drying air at 65° C. was fed out from the lower air duct 87c to dry the casting film 16. Note that the oxygen concentration in the drying atmosphere on the casting belt 44 was kept to 5 vol % by substituting the air for nitrogen gas. In order to keep the oxygen concentration to 5 vol %, the inner air of the drying atmosphere was substituted by nitrogen gas. The solvent vapor in the casting chamber 81 was recovered by setting the temperature of exit of the condenser 82 to −3° C.

The static fluctuation near the casting die 41 was reduced to at most ±1 Pa. When the casting film 16 has the self-supporting property, the casting film 16 was peeled as the wet film 18 from the casting belt 44 with support of the roller 89. In order to reduce the peeling defects, the percentage of the peeling speed (the drawing speed of the roller 89) to the speed of the casting belt 44 was controlled from 100.1% to 110%. The solvent vapor generated in the evaporation is condensed by the condenser 86 at −3° C. to a liquid state, and recovered by the recovering device 83. The water content of the recovered solvent was adjusted to at most 0.5%. Further, the air from which the solvent components were removed was heated again and reused for the drying air. The wet film 18 was transported with the rollers in the transfer area 90 toward the tenter drying chamber 45. In the transfer area 90, the drying air at 60° C. was fed to the wet film 18 from the air blower 91. A tenter draw as a magnitude of the film length from the roller 89 to the entrance of the tenter drying chamber 45 was 103.0%.

In the tenter drying chamber 45, both side edge portions of the wet film 18 were clipped or held by the clips 132a, 132b, and the wet film 18 was transported through the first-third zones 121-123. During the transport in the tenter drying chamber 45, the predetermined stretching, relaxation and drying were made to the wet film 18.

The clips 132a, 132b are cooled by a heat transfer medium whose temperature was 20° C. The transportation of the clips 132a, 132b was made by running the chains 131a, 131b, and the running speed of the chain sprocket 134a, 134b was at most 0.5%. The oxygen concentration in the drying atmosphere in the tenter drying chamber 45 was kept to 5 vol % by substituting the air for nitrogen gas.

The conditions of the air blow supplied into the first zone 121 was adjusted with use of the air conditioner 141, such that the temperature T1 of the wet film 18 might be a predetermined value in the first zone 121. Further, the preheating of the wet film 18 was made while the wet film 18 is transferred through the first zone 121. Note that the content Z1 of the remaining solvent in the wet film 18 in the first zone 121 was around 10 wt. %.

The conditions of the air blow supplied into the second zone 122 was adjusted with use of the air conditioner 142, such that the temperature T2 of the wet film 18 might be 120° C. in the second zone 122. Further, the magnitude L2/L1 of the stretching of the wet film 18 in the second zone 122 was 105%. The preheating of the wet film 18 was made while the wet film 18 is transferred through the second zone 122. Note that the content Z2 of the remaining solvent in the wet film 18 in the second zone 122 was around 6 wt. %. Since the stretching was made in the second zone 122, the first disorientation of the optical axis occurred.

The conditions of the air blow supplied into the third zone 123 was adjusted with use of the air conditioner 143, such that the temperature T2 of the wet film 18 might be 135° C. in the third zone 123. Further, the magnitude L3/L2 of the stretching of the wet film 18 in the third zone 123 was 95%. The preheating of the wet film 18 was made while the wet film 18 is transferred through the third zone 123. Note that the content Z3 of the remaining solvent in the wet film 18 in the third zone 123 was around 0.5 wt. %. Note that the first disorientation of the optical axis that occurred in the first zone 121, and almost not changed. Then the wet film 18 was fed out from the tenter drying chamber 45 to the edge slitting device 46.

The solvent vapor evaporated in the tenter drying chamber 45 was condensed and liquidized at −3° C. by a condenser (not shown) for recovery of the solvent. Thereafter the water content of the recovered solvent was adjusted to at most 0.5 wt. %.

In 30 seconds from exit of the tenter drying chamber 45, both side edge portions of the film 22 were slit off in the edge slitting device 46. In this experiment, each side portion of 50 mm in the widthwise direction of the film 22 was determined as the side edge portion, which were slit off by an NT type slitter of the edge slitting device 46. The slit side edge portions were sent to the crusher 93 by applying air blow from a blower (not shown), and crushed to tips about 80 mm². The tips were stored into edge silos for reusing as raw material with the TAC flakes for the dope production. Before the drying at the high temperature in the drying chamber 47, the pre-heating of the film 22 was made in a pre-heating chamber (not shown) in which the air blow at 100° C. was supplied.

The film 22 was dried at high temperature in the drying chamber 47, which was partitioned into four partitions. Air blows whose temperatures were 120° C., 130° C., 130° C. and 130° C. from the upstream side were fed from air blowers (not shown) to the partitions. The transporting tension of each roller 100 to the film 22 was 100 N/m. The drying was made for ten minutes such that the content of the remaining solvent might be 0.3 wt. %. The lapping angle of any of the rollers 100 was in the range of 80° and 190°. The rollers 100 were made of aluminum or carbon steel. On the surface, the hard chrome coating was made. The surfaces of the rollers 100 were flat or processed by blast of matting process. The swing of the roller in the rotation was in 50 μm. Further, the bending of each roller 100 at the tension of 100 N/m was reduced to at most 0.5 mm.

The solvent vapor contained in the drying air is removed with use of the adsorbing device 101 in which an adsorbing agent was used. The adsorbing agent was active carbon, and the desorption was performed with use of dried nitrogen. The recovered solvent was reuse as the solvent for the dope preparation after the water content might be at most 0.3 wt. %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 wt %, and almost of the remaining solvent vapor was recovered by the adsorption recovering.

The dried film 22 was transported into a first humidity control chamber (not shown). Between the drying chamber 47 and the first humidity control chamber, there was the transfer area 90 into which a drying air at 110° C. was fed. In the first humidity control chamber, an air whose temperature and dewing point were respectively 50° C. and 20° C. was fed. Further, the film 22 was transported into a second humidity control chamber (not shown) for preventing the curling of the film 22. In the second humidity control chamber, an air whose temperature and humidity were respectively 90° C. and 70% was directly applied.

After the humidity control, the film 22 was cooled in the cooling chamber 48 such that the temperature of the film might be at most 30° C. Then the edge slitting of both film edge portions were made. Further, the compulsory neutralization device (or neutralization bar) 102 eliminated the charged electrostatic potential of the film 22 in the range of −3 kV to +3 kV. After the neutralization, the embossing of both side portions of the film 22 was made by the knurling rollers 103 to provide the knurling. The knurling area was 10 mm in width, and the knurling pressure was determined such that the maximal emboss height might be 12 μm in average larger than the averaged thickness.

The film 22 was transported to the winding chamber 49, whose inside temperature and humidity were respectively kept to 28° C. and 70%. Further, a compulsory neutralization device (not shown) was provided, such that the charged electrostatic potential of the film might be in the range of −1.5 kV to +1.5 kV. The film 22 was wound up around the winding shaft 110 with use of the press roller, such thus the film roll might be obtained. The thickness of the film 22 was 70 μm and the width was 1500 mm.

### Example 2

The wet film 18 whose content Z1 of the remaining solvent was about 12 wt. % was guided to the second zone 122. In the second zone 122, the stretching was made such that the magnitude L2/L1 might be 103%, and the drying was made such that the content Z2 of the remaining solvent in the wet film 18 might be 5 wt. %. Further, in the third zone 123, the relaxation was made such that the magnitude L3/L2 might be 97%, and the drying was made such that the temperature T3 might be 125° C. and the content Z3 of the remaining solvent in the wet film 18 might be 0.7 wt. %. Other conditions were the same as Example 1.

### Example 3

The wet film 18 whose content Z1 of the remaining solvent was about 11 wt. % was guided to the second zone 122. In the second zone 122, the stretching was made such that the magnitude L2/L1 might be 102%, and the drying was made such that the temperature T2 might be about 115° C. and the content Z2 of the remaining solvent in the wet film 18 might be 5 wt. %. Further, in the third zone 123, the relaxation was made such that the magnitude L3/L2 might be 96%, and the drying was made such that the temperature T3 might be 128° C. and the content Z3 of the remaining solvent in the wet film 18 might be 0.6 wt. %. Other conditions were the same as Example 1.

### Example 4

The wet film 18 whose content Z1 of the remaining solvent was about 9 wt. % was guided to the second zone 122. In the second zone 122, the stretching was made such that the magnitude L2/L1 might be 100%, and the drying was made such that the content Z2 of the remaining solvent in the wet film 18 might be 7 wt. %. Other conditions were the same as Example 1.

### Example 5

The wet film 18 whose content Z1 of the remaining solvent was about 10 wt. % was guided to the second zone 122. In the second zone 122, the stretching was made such that the magnitude L2/L1 might be 98%, and the drying was made such that the content Z2 of the remaining solvent in the wet film 18 might be 6 wt. %. Other conditions were the same as Example 1.

[Estimation of Film]

In the above examples, the estimation of the film was made by observing the smoothness of the film and measuring the random disorientation of the slow axis in the following methods.

[Observation of Smoothness of Film]

Part of the film produced in the above examples was sampled to be 1.5 m in length and original in width. While a reflection light is applied to the sampled, the scale of the unevenness observed with eyes diagonally. If the scale was so small to use the film as the film product, the estimation about the smoothness was A. If the scale was a little large but the film can be used as the film product, the estimation about the smoothness was B. If the scale was too large small to use the film as the film product, the estimation about the smoothness was C.

[Measurement of Disorientation of Slow Axis]

The disorientation of the optical axis was measured by an automatic birefringence meter (KOBRA-21DH, produced by Oji Scientific Instruments). The sampling of the film 22 for the measurement was made as follows. The cutting of the film 22 was made with use of a cutting plotter at two positions, namely at the middle of the film 22, and at a position which is 15 cm apart from the film edge. Thus the size of each of the two obtained samples might be 5 cm squares. An angle of the slow axis to the lengthwise direction of the film 22 was measured by the automatic birefringence meter, and the difference between the two samples was examined. The difference is called an axial difference 1 in the followings.

If the axial difference 1 is between −2° and 2°, the estimation is A (good). If the axial difference 1 is at most −2° and at least 2°, the estimation is C (bad)

The results of the estimations and the production conditions are shown in Table 1.

TABLE 1

| | Production Conditions | | | | | | |
|---|---|---|---|---|---|---|---|
| | Second Zone | | Third Zone | | | | |
| | T2 | L2/L1 | T3 | L3/L2 | Diff. | Est. | Est. |
| | (° C.) 0 | (%) | (° C.) | (%) | Of SA | of SA | of Sm. |
| Ex. 1 | 120 | 105 | 135 | 95 | 0 | A | A |
| Ex. 2 | 120 | 103 | 125 | 97 | 0 | A | A |
| Ex. 3 | 115 | 102 | 128 | 96 | 0 | A | A |
| Ex. 4 | 120 | 100 | 135 | 95 | −5 | C | C |
| Ex. 5 | 120 | 98 | 135 | 95 | −3 | C | C |

Diff. of SA: Difference of Slow Axis
Est. of SA: Estimation of Slow Axis
Est. of Sm: Estimation of Smoothness

As shown in Table 1, the produced film has the excellent smoothness of the film surface in Examples 1-3 to which the present invention was applied. In these films, the random disorientation the slow axis was reduced. However, the film surface of the produced film in each Example 4 & 5 had unevenness and the smoothness was not adequate to the film product, and the random disorientation of the slow axis was too large.

As the results, in the present invention, since the second disorientation of the optical axis is generated previously in the stretching process 32, the second disorientation of the optical axis cancels the first disorientation of the optical axis which is generated in the free-shrinkage drying process 33.

Consequently, the produced film has in total no effects caused by the random disorientation of the optical axes. In the present invention, the generation of the surface defect and the random disorientation of the optical axis are reduced in the produced film.

Various changes and modifications are possible in the present invention and may be understood to be within the present invention.

What is claimed is:

1. A solution casting method, comprising:
casting onto a support a dope containing a polymer and a solvent, so as to form a casting film;
providing a self supporting property for said casting film;
peeling said casting film as a wet film from said support;
performing a non-stretch-drying of drying said wet film with non-stretching said wet film in a widthwise direction of said wet film;
drying said wet film with stretching said wet film in said widthwise direction before the non-stretch drying step, so as to cancel a first disorientation of optical axis that occurs by a bowing phenomena in the non-stretch-drying step, the stretching being performed so as to provide said wet film with a second disorientation of optical axis for cancelling said first disorientation.

2. A solution casting method claimed in claim 1, wherein, while said stretching of said wet film is performed, said wet film has a higher temperature than a glass transition temperature Tg of said polymer, a content of a remaining solvent in said wet film is in the range of 5 wt. % to 10 wt. %, and a stretch magnitude of the stretching is at least 101% and less than 120%.

3. A solution casting method claimed in claim 1, wherein a temperature of said wet film is in the range of 20° C. to 200° C. in the non-stretch-drying step, and an extending of said wet film in a lengthwise direction is performed.

4. A solution casting method claimed in claim 1, further comprising steps of:
performing a pre-drying of said wet film before the stretch-drying;
satisfying at least one of first, second and third conditions in the stretch-drying or the pre-drying;
wherein the first condition is that the temperature of said wet film is in the range of 60° C. to 80° C. when the content of the remaining solvent is in the range of 30 wt. % to 60 wt. %;
wherein the second condition is that the temperature of said wet film is in the range of 95° C. to 110° C. when the content of the remaining solvent is in the range of 8 wt. % to 30 wt. %;
wherein the third condition is that the temperature of said wet film is in the range of 100° C. to 120° C. when the content of the remaining solvent is in the range of 5 wt. % to 8 wt. %.

5. A solution casting method claimed in claim 1, wherein said polymer is cellulose acylate.

6. A solution casting apparatus, comprising:
a moving support;
a casting die for casting onto said support a dope containing a polymer and a solvent, so as to form a casting film;
a peeling member for peeling a casting film as a wet film from said support;
a non-stretch-drying section for drying said wet film with non-stretching in a widthwise direction;
a stretch-drying section for drying said wet film with stretching in a widthwise direction, so as to cancel a first disorientation of optical axis that occurs by a bowing phenomena in said non-stretch drying section, said stretch-drying section being disposed in an upstream side from said non-stretch drying section, the stretching being performed so as to provide a second disorientation of optical axis for canceling said first disorientation of optical axis.

7. A solution casting apparatus claimed in claim 6, further comprising:
a temperature controller for controlling a temperature of said wet film in accordance with a content of remaining solvent of said wet film; and
a magnitude controlling device for controlling a stretch magnitude of said stretching of said wet film in said widthwise direction.

8. A solution casting apparatus claimed in claim 7,
wherein said wet film in said stretch-drying section has a higher temperature than a glass transition temperature Tg of said polymer, and a content of a remaining solvent in the range of 5 wt. % to 10 wt. %; and
wherein a stretch magnitude of the stretching is at least 101% and less than 120% when said second disorientation is provided for said wet film.

9. A solution casting apparatus claimed in claim 6, wherein, while the drying is performed by said non-stretch-drying section, the content of said remaining solvent in said wet film is at most 5 wt. % and a temperature of said wet film is in the range of 20° C. to 200° C.

10. A solution casting apparatus claimed in claim 6, further comprising:
a pre-drying device for performing a pre-drying of said wet film, disposed in an upstream side from said stretch-drying section, at least one of first, second, third conditions being satisfied in the stretch drying or in the pre-drying;
wherein the first condition is that the temperature of said wet film is in the range of 60° C. to 80° C. when the content of the remaining solvent is in the range of 30 wt. % to 60 wt. %;
wherein the second condition is that the temperature of said wet film is in the range of 95° C. to 110° C. when the content of the remaining solvent is in the range of 8 wt. % to 30 wt. %;
wherein the third condition is that the temperature of said wet film is in the range of 100° C. to 120° C. when the content of the remaining solvent is in the range of 5 wt. % to 8 wt. %.
